(19) United States
(12) Patent Application Publication
(10) Pub. No.: US 2017/0109276 A1
(43) Pub. Date: Apr. 20, 2017

(54) MEMORY SYSTEM AND OPERATION METHOD THEREOF

(71) Applicant: SK hynix Inc., Gyeonggi-do (KR)

(72) Inventor: Jong-Min LEE, Gyeonggi-do (KR)

(21) Appl. No.: 15/068,353

(22) Filed: Mar. 11, 2016

(30) Foreign Application Priority Data
Oct. 15, 2015 (KR) 10-2015-0143847

(51) Int. Cl. G06F 12/02

(52) U.S. Cl. CPC G06F 12/0253; G06F 2212/1044

(57) ABSTRACT

A memory system includes a memory device comprising a plurality of blocks, and a controller suitable for erasing at least one victim block selected from among the plurality of blocks in a first garbage collection operation, and preparing a second garbage collection operation for one or more other blocks, except for the victim block among the plurality of blocks during a period in which the victim block is erased.

### CROSS-REFERENCE TO RELATED APPLICATIONS

This application claims priority under 35 U.S.C, §119 to Korean Patent Application No. 10-2015-0143847, filed on Oct. 15, 2015 in the Korean Intellectual Property Office, the disclosure of which is incorporated herein by reference in its entirety.

### BACKGROUND

1. Field

Exemplary embodiments of the present invention relate generally to a semiconductor design technology and, more particularly, to a memory system having a garbage collection operation.

2. Description of the Related Art

The computer environment paradigm has shifted to ubiquitous computing systems that can be used anywhere and at any time As a result, the use of portable electronic devices such as mobile phones, digital cameras and notebook computers has been increasing rapidly. These portable electronic devices generally use a memory system having a memory device for storing data, that is, a data storage device. A data storage device may be used as a main or an auxiliary memory device of a portable electronic devices.

Data storage devices using memory devices provide excellent stability, durability, high information access speed and low power consumption since they have no moving parts. Examples of data storage devices having such advantages include universal serial bus (USB) memory devices, memory cards having various interfaces, and solid state drives (SSD).

### SUMMARY

Various embodiments of the present invention are directed to a memory system capable of efficiently performing garbage collection and an operation method thereof.

In an embodiment of the present invention, a memory system may include: a memory device comprising a plurality of blocks; and a controller suitable for erasing at least one victim block selected from among the plurality of blocks in a first garbage collection operation, and preparing a second garbage collection operation for one or more other blocks, except for the victim block among the plurality of blocks during a period in which the victim block is erased.

The controller may be further suitable for copying valid data of the victim block>into a target free block in the first garbage collection operation.

The controller may be suitable for preparing the second garbage collection operation for the one or more other blocks by determining whether to perform the second garbage collection operation.

The controller may determine whether to perform the second garbage collection operation based on at least one of a host request operation for the memory device, a valid data rate for the one or more other blocks, and a number of free blocks of the plurality of blocks.

The controller may determine that the second garbage collection operation is not to be performed when the host request operation for the memory device exists in the period in which the victim block is erased.

The controller may determine that the second garbage collection operation is not to be performed when there is no block having a valid data rate lower than a preset rate in the one or more other blocks.

The controller may determine that the second garbage collection operation is not to be performed when the number of free blocks of the plurality of blocks is larger than a preset number.

When it is determined to perform the second garbage collection operation for the one or more other blocks, the controller may select at least one block from among the one or more other blocks, of which the valid data rate is lower than a preset rate, as another victim block to which the second garbage collection operation is applied.

The controller may calculate a time required for performing the second garbage collection operation for the another victim block.

The controller may select a target free block among the one or more other blocks for the another victim block based on a number of times of erasing/writing operations.

In another embodiment of the present invention, an operation method of a memory system including a memory device comprising a plurality of blocks, the operation method may include: erasing at least one victim block selected from among the plurality of blocks in a first garbage collection operation; and preparing a second garbage collection operation for one or more other blocks, except for the victim block among the plurality of blocks, in a period in which the victim block is erased.

The operation method of a memory system may further include: copying valid data of the victim block into a target free block in the first to garbage collection operation.

The preparing of the second garbage collection operation for the one or more other blocks may include determining whether to perform the second garbage collection operation.

The determining of whether to perform the second garbage collection operation may include: determining whether to perform the second garbage collection operation based on at least one of a host request operation for the memory device, a valid data rate for the one or more other blocks, and a number of free blocks of the plurality of blocks.

The determining of whether to perform the second garbage collection operation may include: when the host request operation for the memory device exists in the period in which the victim block is erased, determining that the second garbage collection is controlled not to be performed.

The determining of whether to perform the second garbage collection operation may include: when there is no block having a valid data rate lower than a preset rate in the one or more other blocks, determining that the second garbage collection is controlled not to be performed,

The determining of whether to perform the second garbage collection operation may include: when the number of free blocks of the plurality of blocks is larger than a preset number, determining that the second garbage collection is controlled not to be performed.

The operation method of a memory system may further include: when it is determined to perform the second garbage collection operation for the one or more other blocks, selecting at least one block from among the other blocks, of which the valid data rate is lower than a preset rate, as another victim block to which the second garbage collection operation is applied.

The preparing may further include calculating a time required for performing the second garbage collection operation for the another victim block.

The preparing may further include: selecting a target free block among the one or more other blocks for the another victim block based on a number of times of erasing/writing.

According to the present technology, in a period of erasing a victim block completely subjected to an operation for moving internal valid data through garbage collection firstly performed among a plurality of blocks included in a memory device, an operation of subsequent garbage collection is prepared. That is, an operation period in which continuous garbage collections overlap each other is ensured

Consequently, it is possible to significantly reduce a time required for continuous garbage collections.

### BRIEF DESCRIPTION OF THE DRAWINGS

FIG. 1 is a diagram illustrating a data processing system including a memory system, according to an embodiment of the present invention.

FIG. 2 is a diagram illustrating a memory device in a memory system, according to an embodiment of the present invention.

FIG. 3 is a circuit diagram illustrating a memory block in a memory device, according to an embodiment of the present invention.

FIGS. 4, 5 6, 7, 8 9 10 and 11 are diagrams illustrating a memory device, according to embodiments of the present invention,

FIG. 12A to FIG. 12C are diagrams illustrating a continuous garbage collection operation in a memory system, according to an embodiment of the present invention.

### DETAILED DESCRIPTION

Various embodiments will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the invention to those skilled in the art Throughout the disclosure, like reference numerals refer to like parts throughout the various figures and embodiments of the present invention.

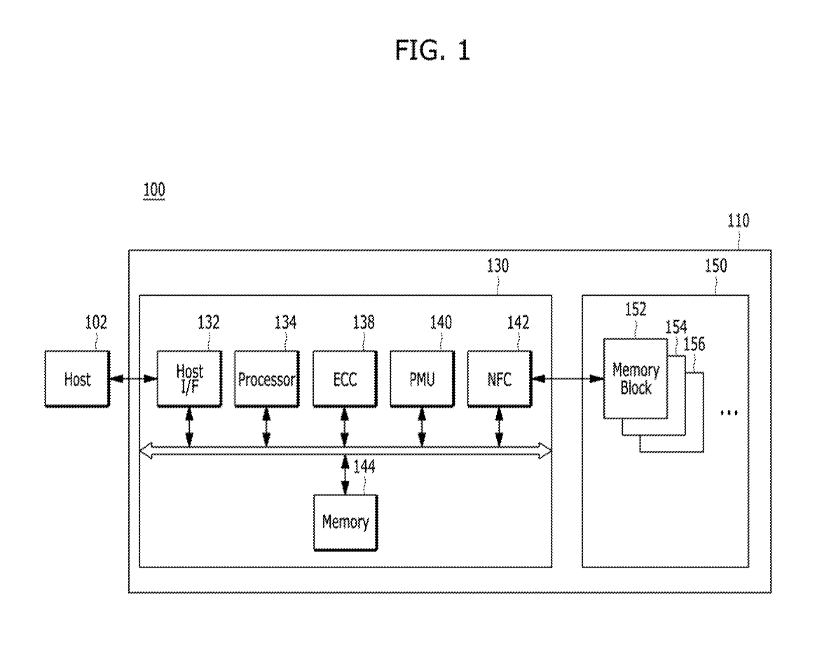

FIG. 1 is a block diagram illustrating a data processing system including a memory system according to an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words the memory system 110 may be used as a main memory system or an auxiliary memory system of the host 02. The memory system 110 may be implemented with any one of various kinds of storage devices, according to the protocol of a host interface to be electrically coupled with the host 102. The memory system 110 may be implemented with any one of various kinds of storage devices such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a to mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC) an RS-MMC and a micro-MMC, a secure digital (SD) card, a mini-SD, a micro-SD and an SDHC, and a universal flash storage (UFS) device.

For another instance, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box a digital camera, a digital multimedia broadcasting (DMB) player, a three-dimensional (3D) television, a smart television a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, or one of various component elements configuring a computing system.

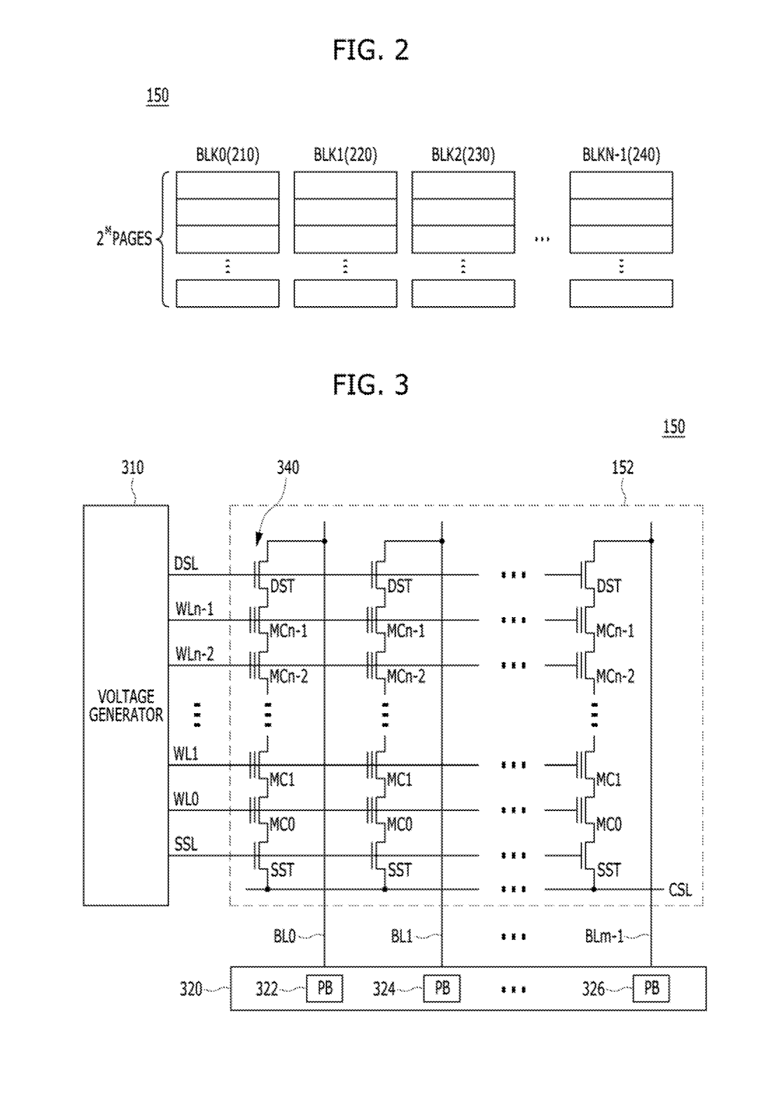

The memory device 150 of the memory system 110 may retain stored data when power supply is interrupted and in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device—150 in response to a request from the host 102. The controller 130 may provide the data read from the memory device 150, to the host 1g, and store the data provided from the host 102 into the memory device 150. To this end the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghern (BCH) code, a turbo code a Reed-Solomon (RS) code a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the to memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, and a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2 the memory device 150 may include a plurality of memory blocks, for example, zeroth to (N-1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines are electrically coupled.

Also, the memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell _{>}strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MCD to MCn-1 may be electrically coupled in series between the select transistors DST and SST. The respective memory cells MC0 to MCn-1 may be configured by multi-level cells (MLC) each of which stores data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate to a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

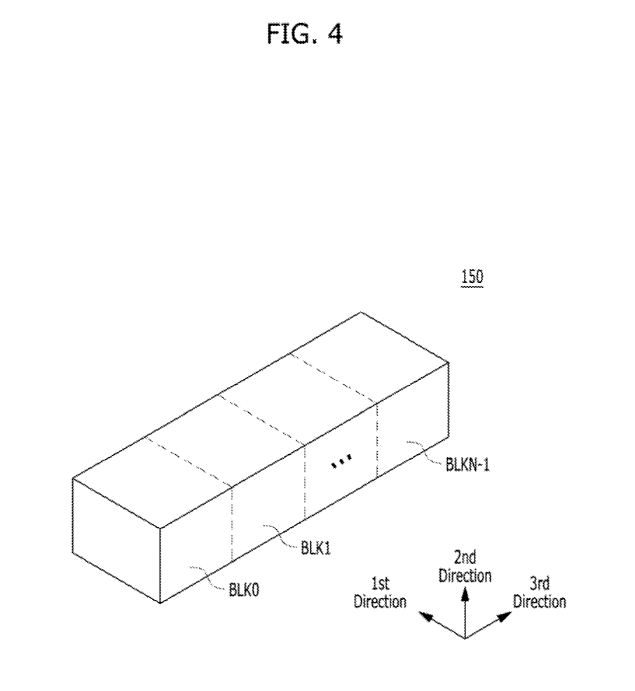

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN-1, and each of the memory blocks BLK0 to BLKN-1 may be realized in a three-dimensional (3D) structure or a vertical structure. The respective memory blocks BLK0 to BLKN-1 may include structures which extend in first to third directions, for example, an x-axis direction, a y-axis direction and a z-axis direction.

The respective memory blocks BLK0 to BLKN-1 may include a plurality of NAND strings NS which extend in the second direction. The plurality of NAND strings NS may be provided in the first direction and the third direction. Each NAND string NS may be electrically coupled to a bit line BL, at least one source select line SSL, at least one ground select line GSL, a plurality of word lines WL, at least one dummy word line DWL, and a common source line CSL. Namely, the respective memory blocks BLK0 to BLKN-1 may be electrically coupled to a plurality of bit lines BL, a plurality of source select lines SSL, a plurality of ground select lines GSL, a plurality of word lines WL, a plurality of dummy word lines DWL, and a plurality of common source lines CSL.

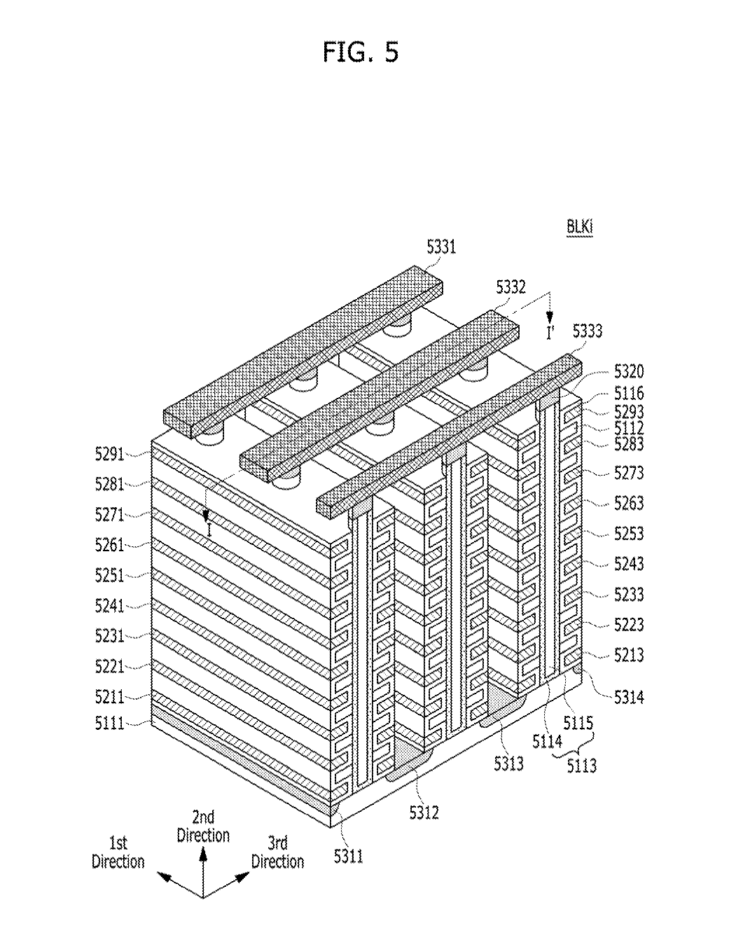

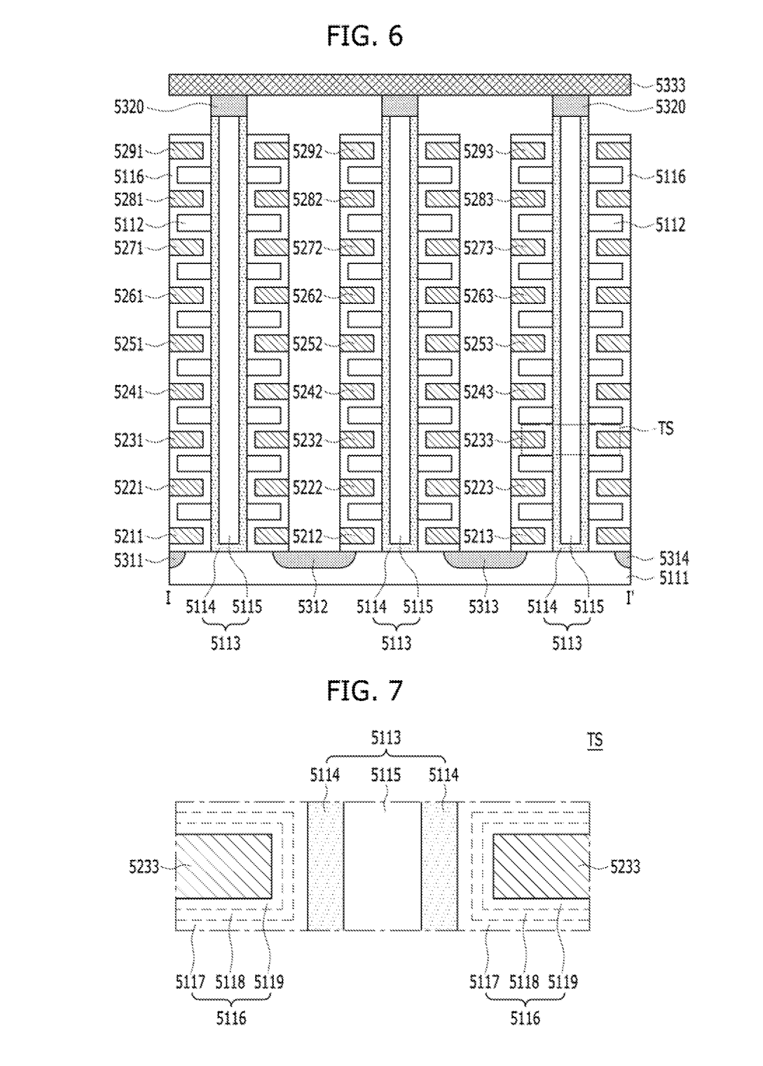

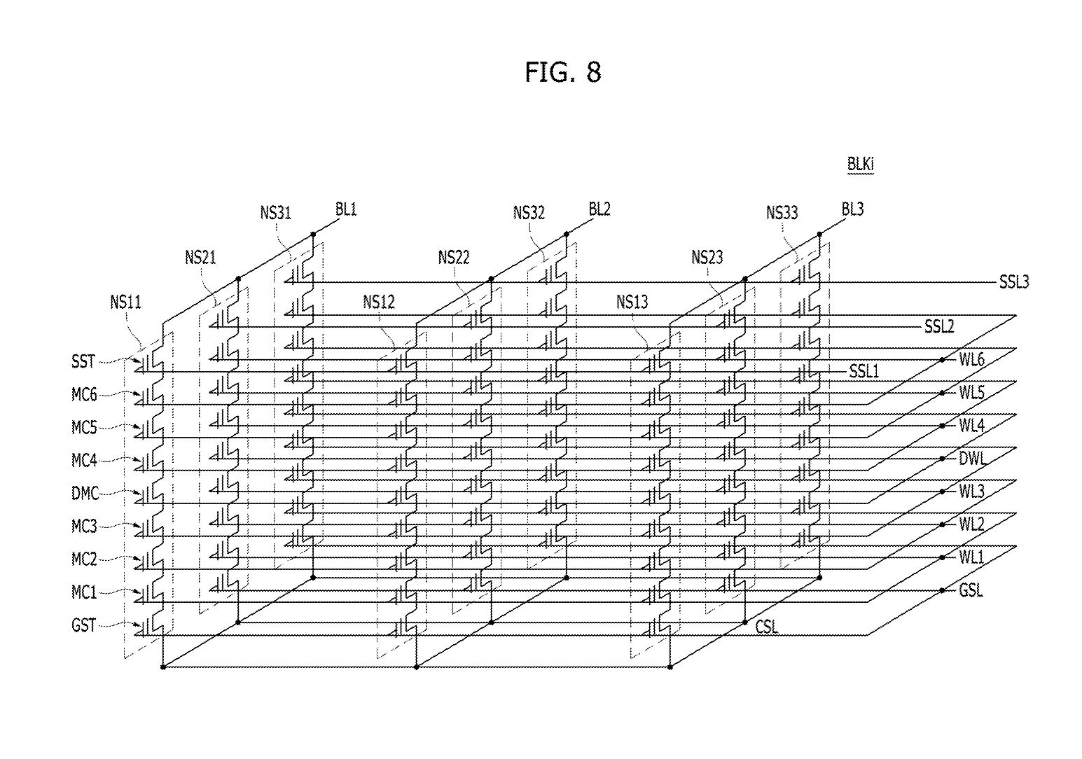

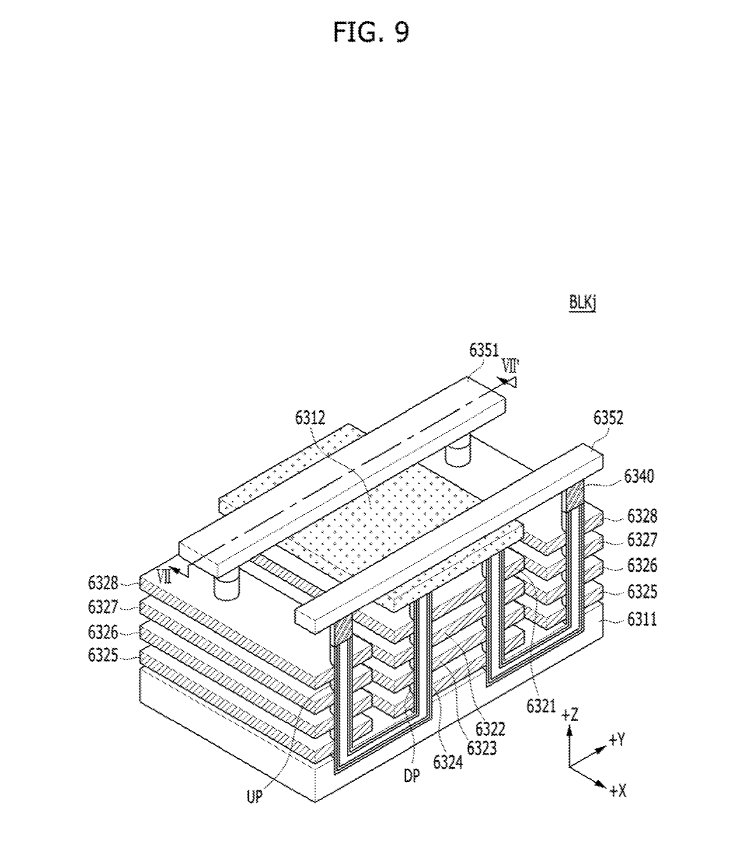

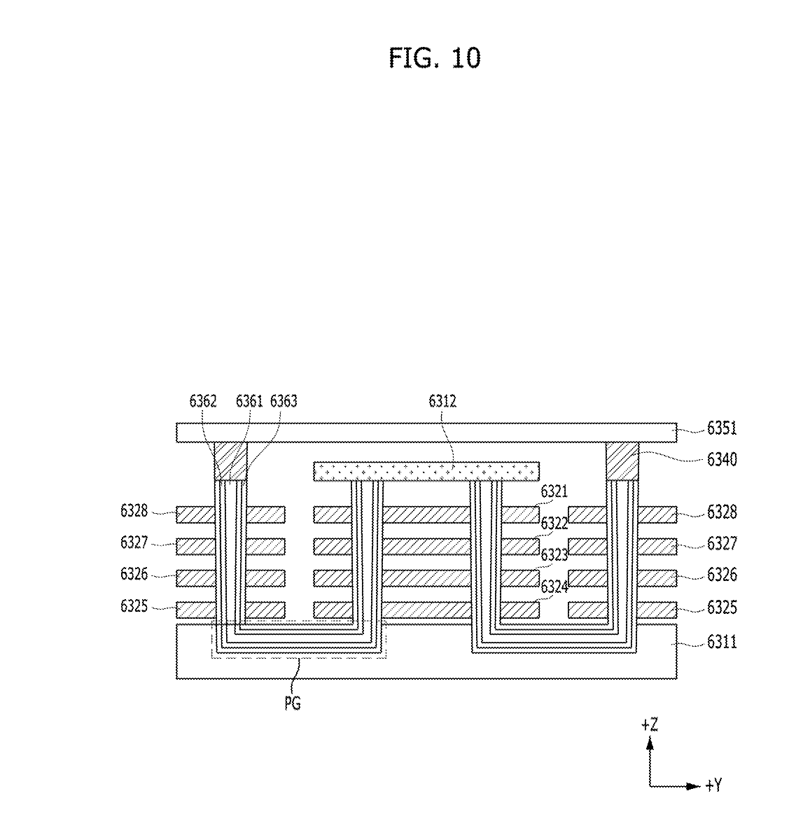

FIG. 5 is a perspective view of one BLKi of the plural memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide,

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over to the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled with through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first: to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer such as an aluminum oxide layer, a hafnium oxide layer, or the like, which has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillar 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111, e.g., the second direction, and may serve as a NAND flash memory block, for example, of a charge capturing type memory, in which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

FIG. 8 is, an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS, and 6, which extends in the third direction, NAND strings NS13 to NS33 may be provided between a third bit line BL3 and the common source line CSL The third bit line BL3 may correspond to the conductive material 5333 of FIGS. 5 and 6, which extends in the third direction,

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS may be defined by units of rows and columns and NAND strings NS which are electrically coupled to one bit line may form one column. The NAND strings NS11 to NS31 which are, electrically coupled to the first bit line BL1 may correspond to a first column, the NAND strings NS12 to NS32 which are electrically coupled to the second bit line BL2 may correspond to a second column, and the NAND strings NS13 to NS33 which are electrically coupled to the third bit line BL3 may correspond to a third column. NAND strings NS which are electrically coupled to one source select line SSL may form one row. The NAND strings NS11 to NS13 which are electrically coupled to a first source select line SSL1 may form a first row, the NAND strings NS21 to NS23 which are electrically coupled to a second source select line SSL2 may form a second row and he NAND strings NS31 to NS33 which are electrically coupled to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively electrically coupled to the different source select lines SSL1, SSL2 and SSL3.

The memory cells at the same height in the NAND strings NS in the same row may share a word line WL. That is, at the same height, the word lines WL electrically coupled to the memory cells MC of the NAND strings NS in different rows may be electrically coupled. Dummy memory cells DMC at the same height in the NAND strings NS of the same row may share a dummy word line DWL. Namely, at the same height or level, the dummy word lines DWL electrically coupled to the dummy memory cells DMC of the NAND strings NS in different rows may be electrically coupled.

The word lines WL or the dummy word lines DWL located at the same level or height or layer may be electrically coupled with one another at layers where the conductive materials 5211 to 5291, 5212 to 5292 and 5213 to 5293 which extend in the first direction may be provided. The conductive materials 5211 to 5291, 5212 to 5292 and 5213 to 5293 which extend in the first direction may be electrically coupled in common to upper layers through contacts. At the upper layers, the conductive materials 5211 to 5291, 5212 to 5292 and 5213 to 5293 which extend in the first direction may be electrically coupled. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be electrically coupled to the ground select line GSL.

The common source line CSL may be electrically coupled to the NAND strings NS. Over the active regions and over the substrate 5111, the first to fourth doping regions 5311 to 5314 may be electrically coupled. The first to fourth doping regions 5311 to 5314 may be electrically coupled to an upper layer through contacts and, at the upper layer, the first to fourth doping regions 5311 to 5314 may be electrically coupled.

Namely, as shown in FIG. 8, the word lines WL of the same height or level may be electrically coupled. Accordingly, when a word line WL at a specific height is selected, all NAND strings NS which are electrically coupled to the word line WL may be selected. The NAND strings NS in different rows may be electrically coupled to different source select lines SSL. Accordingly, among the NAND strings NS electrically coupled to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3 adjacent to the ground select transistor GST may be referred to as a lower memory cell group, and memory cells, for example, MC4 to MC6, adjacent to the string select transistor SST may be referred to as an upper memory cell group.

Herein below, detailed descriptions will be made with reference to FIGS. 9 to 11, which show the memory device in the memory system according to an embodiment implemented with a three-dimensional (3D) nonvolatile memory device different from the first structure.

FIG. 9 is a perspective view schematically illustrating the memory device implemented with the three-dimensional (3D) nonvolatile memory device, which is different from the first structure described above with reference to FIGS. 5 to 8, and showing a memory block BLKj of the plurality of memory blocks of FIG. 4. FIG. 10 is a cross-sectional view illustrating the memory block BLKj taken along the line VII-VII′ of FIG. 9.

Referring to FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the embodiment for the sake of convenience that the substrate 6311 is p-type silicon, it is to be noted that the substrate 6311 is not limited to being p-type silicon,

First to fourth conductive materials 6321 to 6324 which extend in the x-axis direction and the y-axis direction are provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362 and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars P. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWU and MWL2 respectively. The fifth and sixth conductive materials 6325 and 6326 serve as third and fourth main word lines MWL3 and MWL4, respectively, the seventh conductive material 6327 may serve as a second dummy word line DWL2 and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the Lower string may include a source select transistor SST, the first dummy memory cell DMC1 and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG, 7, a detailed description thereof will be omitted herein.

FIG. 11 is a circuit diagram illustrating the equivalent circuit of the memory block BLKJ having the second structure as described above with reference to FIGS. 9 and 10. For the sake of convenience, only a first string and a second string, which form a pair in the memory block BLKj in the second structure are shown.

Referring to FIG. 11, in the memory block BLK having the second structure among the plurality of blocks of the memory device 150, cell strings, each of which is implemented with one upper string and one lower string electrically coupled through the pipe gate PG as described above with reference to FIGS. 9 and 10, may be provided in such a way as to define a plurality of pairs.

Namely, in the certain memory block. BLKJ having the second structure, memory cells CG0 to CG31 stacked along a first channel CH1 (not shown), for example at least one source select gate SSG1 and at least one drain select gate DSG1 may form a first string ST1, and memory cells CG0 to CG31 stacked along a second channel CH2 (not shown), for example at least one source select gate SSG2 and at least one drain select gate DSG2 may form a second string ST2.

The first string ST1 and the second string ST2 may be electrically coupled to the same drain select line DSL and the same source select line SSL. The first string ST1 may be electrically coupled to a first bit line BL1, and the second string ST2 may be electrically coupled to a second bit line BL2.

While it is described in FIG. 11 that the first string ST1 and the second string ST2 are electrically coupled to the same drain select line DSL and the same source select line SSL, it may be envisaged that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it may be envisaged that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

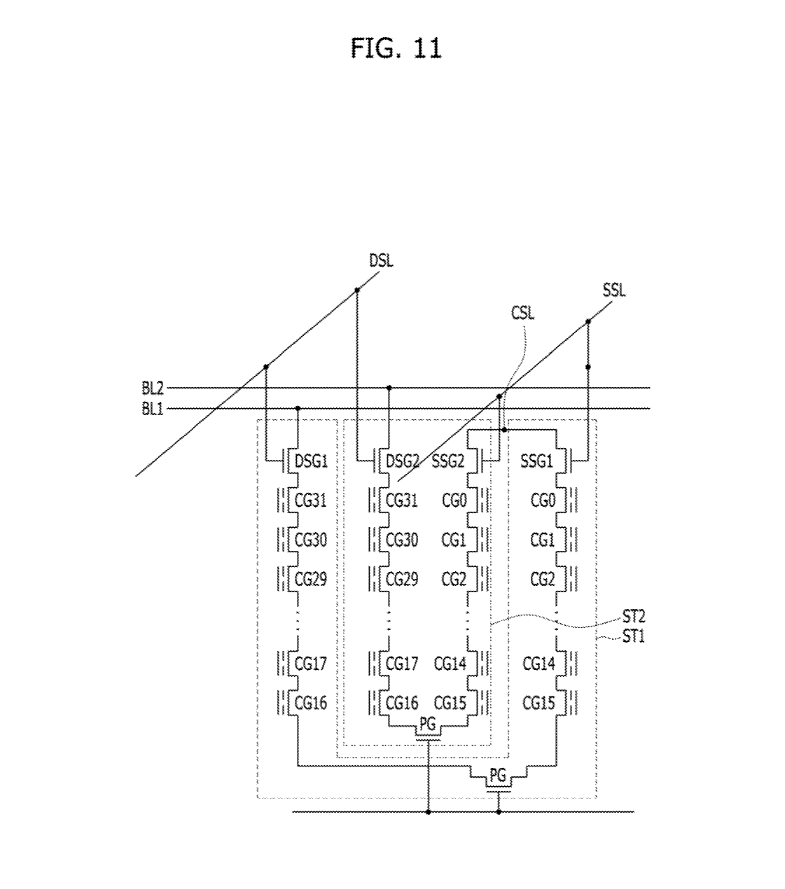

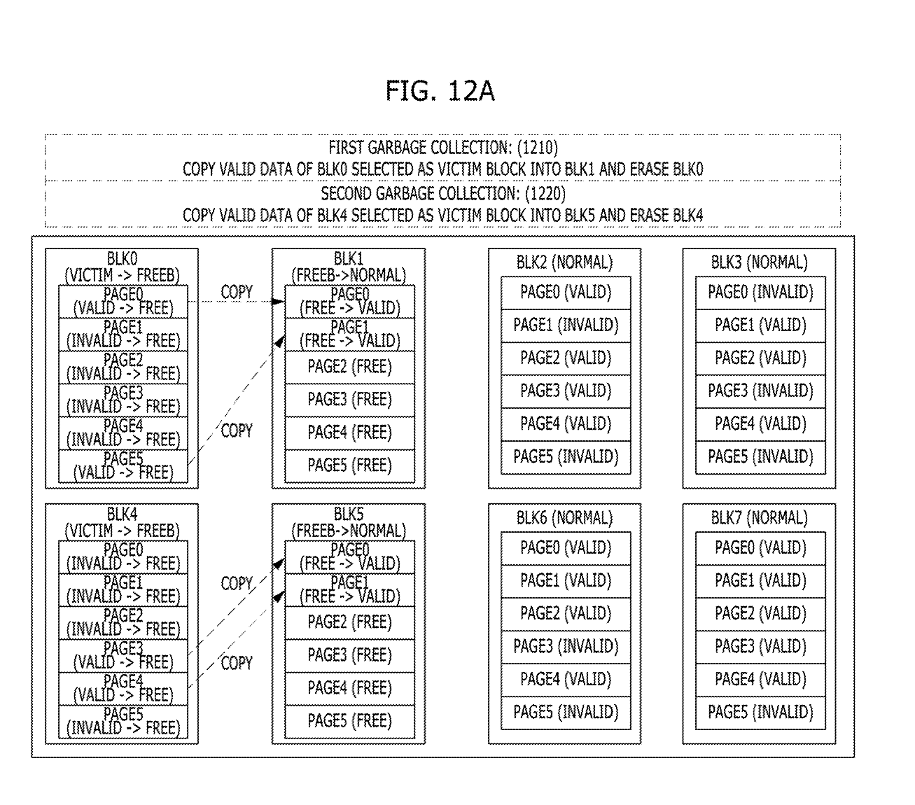

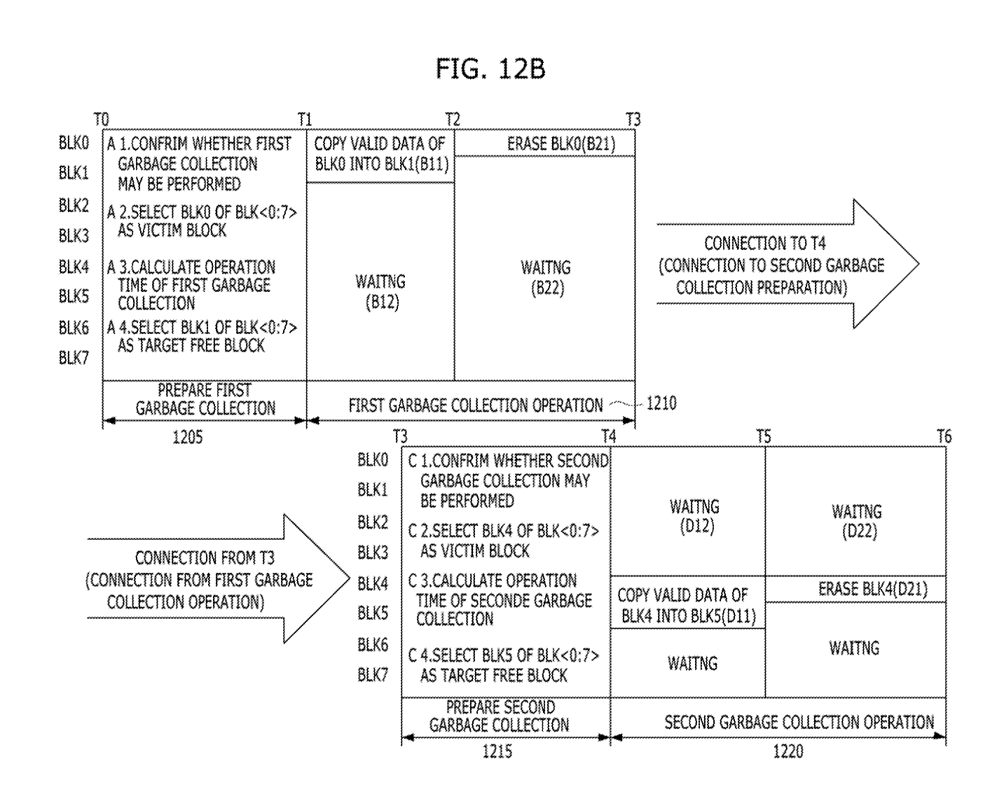

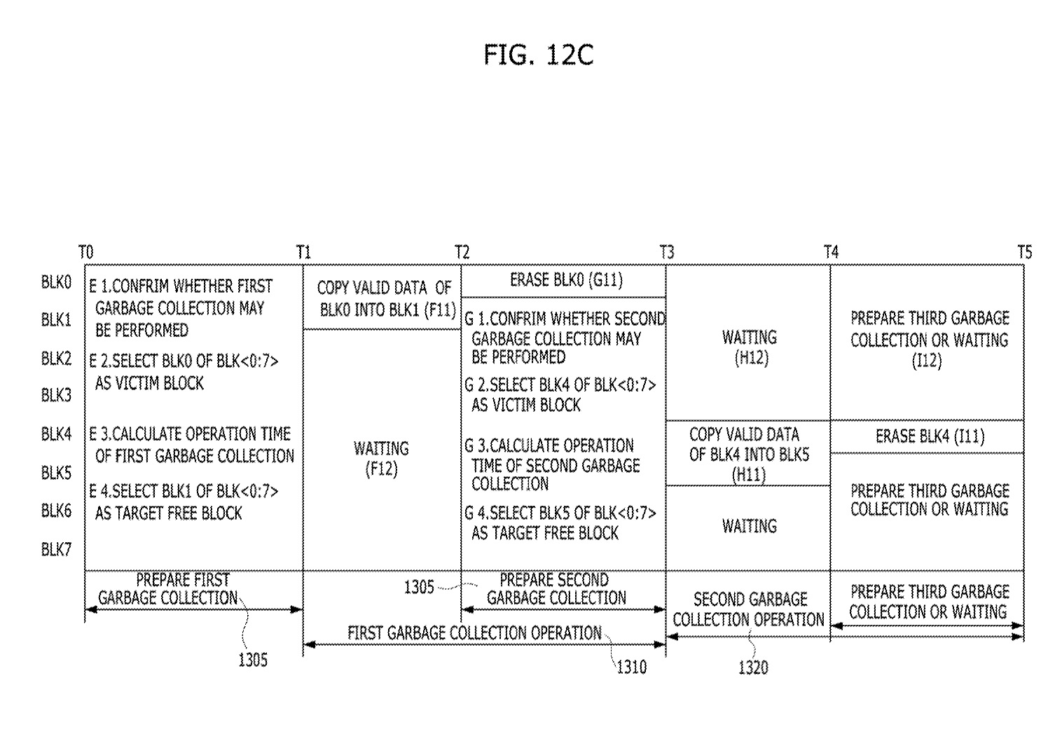

Referring now to FIGS. 12A to 12C a continuous garbage collection operation in a memory system is provided, according to an embodiment of the invention. More specifically, referring to FIG. 12A, it can be understood that the configuration of the memory device 150 of the memory system 110 illustrated in FIG. 1 is illustrated herein in more detail. Accordingly, the memory device 150 may include a plurality of memory blocks BLK0 to BLK7. Each of the plurality of memory blocks BLK0 to BLK7 may include a plurality of pages PAGE0 to PAGE5. FIG. 12A illustrates that the memory device 150 may include, eight memory blocks BLK0 to BLK7 as the plurality of memory blocks for illustrative purposes only. It is noted, that any number of memory blocks may be included in various embodiments of the memory device 150. For example, a larger number of memory blocks may be included in various embodiments of the memory device 150. Furthermore, FIG. 12A illustrates that each of the plurality of memory blocks BLK0 to BLK7 includes six pages PAGE0 to PAGE5 for illustrative purposes only, however, it is noted that any suitable number of pages may be included in each memory block. For example, a larger number of pages may be included in each memory block.

Although not illustrated in FIG. 12A, it can be understood that the controller 130 illustrated in FIG. 1 may perform a garbage collection operation for the plurality of memory blocks BLK0 to BLK7 included in the memory device 150.

A garbage collection operation may be performed since the memory device 150 as a nonvolatile memory device may perform data read/write in units of pages, but perform data erase in units of blocks.

That is, due to the characteristics of a nonvolatile memory device, when the content of data stored in a specific page of the memory device is updated, a method for invalidating the specific page may be employed instead of rewriting data in the specific page and newly writing update content in a free page of the specific block or another free block. In this case, since the data of the invalidated specific page is unused data, it may also be referred to as garbage data.

Data may be updated repeatedly as may be needed thereby increasing the number of invalidated pages. When the number of invalidated pages in a specific block becomes greater than a preset number, then all data of the invalidated pages included in the specific block may be deleted. In this case, an operation for copying data of valid pages included in the specific block into free blocks and erasing the specific block in order to delete all invalid data included in the specific block is called a garbage collection operation.

Referring again to FIG. 12A, a garbage collection operation may be continuously performed for the plurality of memory blocks BLK0 to BLK7 twice. For example, a garbage collection operation as illustrated in FIG. 12A may include a first garbage collection operation 1210 and a second garbage collection operation 1220 which are continuously performed.

In more detail, in a first garbage collection preparation operation, it is assumed that a 0^{th} block BLK0 is selected as a victim block VICTIM and a first block BLK1 is selected as a target free block FREEB.

Accordingly, in the first garbage collection operation 1210 subsequent to the first garbage collection preparation operation, data of a 0^{th} page PAGE0 and a fifth page PAGE5, which are valid pages VALID of the 0^{th} block BLK0, may be copied into a 0^{th} page PAGE0 and a first page PAGE1 of the first block BLK1, respectively. Then the 0^{th} block BLK0 is erased.

Then, in a second garbage collection preparation operation, it is assumed that a fourth block BLK4 is selected as the victim block VICTIM and a fifth block BLK5 is selected as the target free block FREEB.

Accordingly in the second garbage collection operation 1220 subsequent to the second garbage collection preparation operation, data of a third page PAGE3 and a fourth page PAGE4, which are valid pages VALID of the fourth block BLK4, is respectively copied into a 0^{th} page PAGE0 and a first page PAGE1 of the fifth block BLK5, and then the fourth block BLK4 is erased.

Referring to FIG. 12B it is possible to know an order in which the continuous two garbage collection operations described in FIG. 12A, to that is, the first garbage collection operation 1210 and the second garbage collection operation 1220 are performed.

In detail, in order to allow the first garbage collection operation 1210 as described in FIG. 12A to be normally performed, an operation for preparing the first garbage collection is required.

Accordingly, the operation for preparing the first garbage collection 1205 is performed during a time period starting at a time point T0 which is the first time point, and ending at a time point T1.

In this case, the operation for preparing the first garbage collection 1205 may include the following four operations.

The first operation (A1) for preparing the first garbage collection is an operation for confirming whether the first garbage collection 1210 may be performed. This may be needed because a garbage collection operation may not be performed always. Also generally, a garbage collection operation may have a lower priority in the memory device 150 when it is performed.

That is, whether to perform the garbage collection operation may be decided according to at least one of a result obtained by confirming a ratio at which a valid page VALID is included in each of the plurality of memory blocks BLK0 to BLK7 included in the memory device 150 and a result obtained by confirming the number of free blocks FREEB among the plurality of memory blocks BLK0 to BLK7. Even when the garbage collection operation may be required according to the confirmation result, a decision whether to actually perform the garbage collection operation may turn upon whether or not there is a request operation from the host 102.

The operation for confirming the ratio at which a valid page VALID is included in each of the plurality of memory blocks BLK0 to BLK7 is required in that the efficiency of the garbage collection operation is reduced when the valid page VALID is included in each of the plurality of memory blocks BLK0 to BLK7 at a sufficiently high ratio. Accordingly, when blocks including the valid page VALID do not exist in the plurality of memory blocks BLK0 to BLK7 at a ratio lower than a preset ratio, the controller 130 controls the first garbage collection operation 1210 not to be performed.

Furthermore, an operation for confirming the number of free blocks FREEB among the plurality of memory blocks BLK0 to BLK7 is required in that the efficiency of the garbage collection operation is reduced when a sufficient number of free blocks FREEB exist in the plurality of memory blocks BLK0 to BLK7. Accordingly, when a preset number or more free blocks FREEB exist in the plurality of memory blocks BLK0 to BLK7, the controller 130 controls the first garbage collection operation 1210 not to be performed.

As described above, even when the garbage collection operation is required according to at least one of the results obtained by confirming the ratio at which the valid page VALID is included in each of the plurality of memory blocks BLK0 to BLK7 of the memory device 150 and the result obtained by confirming the number of free blocks FREEB among the plurality of memory blocks BLK0 to BLK7, the reason for confirming whether there is a request operation from the host 102 is for allowing the controller 130 to control an operation, in which the memory device 150 reads/writes data requested from the host 102, to have the highest priority. That is, the controller 130 controls an operation such as the garbage collection which is not directly requested from the host 102 and manages data stored in the memory device 150, to have a low priority.

Accordingly, when it is determined that a request from the host 102 is generated or it is not an entrance condition to the first garbage collection 1210 in a preparation period 1205 (T0 to T1) for performing the first garbage collection the order in which the first garbage collection is executed may be delayed or cancelled.

A garbage collection operation may exceptionally be performed before the request from the host 102 according to situations similarly to a case in which the request from the host 102 may not be completed when no garbage collection is performed, however, this is a special case and normally the request from the host 102 should be performed before the garbage collection.

The second operation (A2) for preparing the first garbage collection is an operation for selecting a victim block VICTIM from the plurality of memory blocks BLK0 to BLK7 of the memory device 150. The victim block VICTIM may indicate a block which is erased after data of the valid page VALID is moved through the garbage collection operation and is switched to a free block, that is, a block to be victimized.

Accordingly, the controller 130 may select a block having the lowest valid data rate among the plurality of memory blocks BLK0 to BLK7 as the victim block VICTIM.

For example, as illustrated in FIG. 12A, only two valid pages VALID exist in each of the 0^{th} block BLK0 and the fourth block BLK4 and four or more valid pages VALID exist in each of the second, third, sixth and the seventh blocks BLK2, BLK3, BLK6, and BLK7. Accordingly, the controller 130 may select one of the 0^{th} block BLK0 and the fourth block BLK4 as the victim block VICTIM.

In the embodiment of FIG. 12B, the selection of the 0^{th} block BLK0 as the victim block VICTIM in the first garbage collection preparation operation 1205 and the selection of the fourth block BLK4 as the victim block VICTIM in the second garbage collection preparation operation 1215 are for illustrative purposes only and may be actually operated by other methods.

Since the first block BLK1 and the fifth block BLK5 of the plurality of memory blocks BLK0 to BLK7 are the free blocks FREEB, they are not selected as the victim blocks VICTIM in the first and second garbage collection preparation operations 1205 and 1215.

The third operation (A3) for preparing the first garbage collection is an operation for calculating the operation time of the first garbage collection. That is, the third operation (A3) is an operation for calculating a time from the start to the end of the first garbage collection operation 1210.

A reason for requiring calculating the operation time for the first garbage collection operation may be because the garbage collection operation may have a generally low priority in the memory device 150, similarly to the aforementioned first operation (A1) for preparing the first garbage collection. That is, generally a request from the host 102 may have a priority higher than that of the first garbage collection operation 1210. Accordingly, when the request from the host 102 is suddenly generated after the first garbage collection operation 1210 starts, it may be necessary to prepare in advance a method for handling the request from the host 102.

Accordingly, the controller 130 may calculate in advance a time required for performing the first garbage collection operation 1210. The controller 130 may also schedule the operation order of the first garbage collection operation 1210 based on the time calculation result, thereby preparing the case in which the request from the host 102 is suddenly generated while the first garbage collection operation 1210 is being performed.

FIG. 12A illustrates that the first garbage collection operation 1210 includes only an operation for copying the data of the valid page PAGE of the 0^{th} block BLK0 into the first block BLK1 and an operation for erasing the 0th block BLK0. However, this is only a simplified example of the first garbage collection operation 1210 for convenience. Actually, the first garbage collection operation 1210 may be further complicated. For example, many more blocks may be selected as the victim blocks VICTIM as well as only the 0^{th} block BLK0, and the garbage collection operation may be performed for the blocks. That is, if more than one blocks are selected as victim blocks then the garbage collection operation may be performed for selected victim blocks.

The fourth operation (A4) for preparing the first garbage collection is an operation for selecting a target free block FREEB from the plurality of memory blocks BLK0 to BLK7. The target free block FREEB indicates a free block FREEB which is a target into which the data of the valid page PAGE of the victim block VICTIM selected through the first garbage collection operation 1210 may be copied,

Accordingly, as illustrated in FIG. 12A the controller 130 may select the first and the fifth blocks BLK1 and BLK5 (the free blocks FREEB) as the target free blocks FREEB from the plurality of memory blocks BLK0 to BLK7. The controller 130 may select the first block BLK1 as the target free block FREEB in the first garbage collection preparation operation 1205 and select the fifth block BLK5 as the target free block FREEB in the second garbage collection preparation operation 1215.

When deciding to select the first or the fifth block BLK1 or BLK5 (the free blocks FREEB) as the target free block FREEB, the number of times of erasing/writing operations of each bock may be used as the decision reference. The number of times of erasing/writing operations of the free blocks FREEB may relate to their wear level i.e. their level of deterioration due to use.

In the first garbage collection operation 1210 described in FIGS. 12A and 12B, the 0^{th} block BLK0 may be selected as the victim block VICTIM and the first block BLK1 may be selected as the target free block FREEB for illustrative purposes only. It is noted, that many more blocks may be selected as the victim blocks VICTIM and many more blocks may be selected as the target free blocks FREEB. Also in the second garbage collection operation 1220, the fourth block BLK4 may be selected as the victim block VICTIM and the fifth block BLK5 may be selected as the target free block FREEB for illustrative purposes only. It is also noted that many more blocks may be selected as the victim blocks VICTIM and many more blocks may be selected as the target free blocks FREEB.

Furthermore, in the aforementioned description the sequential arrangement of the four operations (A1-A4) preparing the first garbage collection is also for the purpose of convenience and the four operations need not operate in a specific order. When the operation 1205 for preparing the first garbage collection is completed at the time point T1, the first garbage collection operation 1210 may then be performed,

In detail, the first garbage collection operation 1210 may be divided into a copying operation (811) and an erase operation (B21). The copying operation (B11) for copying the data of the 0^{th} page PAGE0 and the fifth page PAGE5, which are the valid pages VALID of the 0^{th} block BLK0, into the 0^{th} page PAGE0 and the first page PAGE1 of the first block BLK1, respectively, may be performed during a time period starting at time point T1 and ending at a time point T2. The erase operation (B21) for erasing the 0^{th} block BLK0 may be performed in a subsequent period starting at time point T2 and ending at time point T3.

The copying operation (B11) is performed between the 0^{th} block BLK0 and the first block BLK1. Accordingly, the second to seventh blocks BLK2 to BLK7, except for the 0^{th} block BLK0 and the first block BLK1 among the plurality of memory blocks BLK0 to BLK7 may enter a waiting state WAITING (B12) in which no operation is performed.

Furthermore, the operation (B21) for erasing the 0^{th} block BLK0 is performed only in the 0^{th} block BLK0. Accordingly, the first to seventh blocks BLK1 to BLK7, except for the 0^{th} block BLK0, enter a waiting state WAITING (B22) in which no operation is performed..

When T3 is reached and the first garbage collection operation 1210 is completed, an operation 1215 for preparing the second garbage collection may be performed before the second garbage collection operation 1220 is performed subsequently to the first garbage collection operation 1210.

The operation 1215 for preparing the second garbage collection may be the same as the aforementioned operation 1205 for preparing the first garbage collection, except that in the first garbage collection to preparation operation 1205, the 0^{th} block BLK0 is selected as the victim block VICTIM and the first block BLK1 is selected as the target free block FREEB, but in the second garbage collection preparation operation 1215, the fourth block BLK4 is selected as the victim block VICTIM and the fifth block BLK5 is selected as the target free block. FREEB. Accordingly, a detailed description of the second garbage collection preparation operation will be omitted.

When T4 is reached and the operation 1215 for preparing the second garbage collection is completed, the second garbage collection operation 1220 may be performed.

In more detail, the second garbage collection operation 1220 may be divided into a copying operation (D11) and an erase operation (D21). The copying operation (D11) for respectively copying the data of the third page PAGES and the fourth page PAGE4, which are the valid pages VALID of the fourth block BLK4, into the 0^{th} page PAGE0 and the first page PAGE1 of the fifth block BLK5 may be performed in an advanced period starting at time point T4 and ending at time point T5, The erase operation (D21) for erasing the fourth block BLK4 may be performed in a subsequent period starting at time point T5 and ending at time point T6.

The copying operation (D11) is performed between the fourth block BLK4 and the fifth block BLK5. Accordingly, the 0^{th} to third blocks BLK0 to BLK3 and the sixth and seventh blocks BLK6 and BLK7, except for the fourth block BLK4 and the fifth block BLK5 among the plurality of memory blocks BLK0 to BLK7, may enter a waiting state WAITING (D12) in which no operation is performed.

Furthermore, the erase operation (D21) is performed in the fourth block BLK4. Accordingly, the 0^{th} to third blocks BLK0 to BLK3 and the fifth to seventh blocks BLK5 to BLK7, except for the fourth block BLK4, may enter a waiting state WAITING (D22) in which no operation is performed..

When both the first garbage collection operation 121 and the second garbage collection operation 1220 are completed in the aforementioned period from T0 to T6, the 0^{th} block BLK0 and the fourth block BLK4 may sequentially become the free blocks FREER and the first block BLK1 and the fifth block BLK5 may sequentially become blocks including only the valid page VALID as described in FIG. 12A.

In FIGS. 12A and 12B, the first and second garbage collection operations 1210 and 1220 have been described in a simplified manner for convenience, hence, the probability that the first and second garbage collection operations 1210 and 1220 are continued may be considered to be rather small or not sufficient. However in actual operations, the number of blocks requiring the garbage collection operation may be very large, and handling such a large number of blocks through a one-time garbage collection operation, that is, handing such a large number of blocks through the first garbage collection operation 1210 at a time may impose a burden on the operation of the memory device 150 and the garbage collection scheduling of the controller 130. Accordingly, a method may be used for dividing a large number of blocks requiring the garbage collection into a preset number of blocks and sequentially performing the garbage collection for the blocks through continuous garbage collection operations similarly to the method for performing the second garbage collection operation 1220 subsequent to the first garbage collection operation 1210.

Referring to FIG. 12C, it can be understood that the continuous two garbage collection operations 1210 and 1220 described in FIG. 12B are very efficiently performed while overlapping each other. That is the timing diagram of FIG. 12C illustrates the case in which the continuous operation of the first garbage collection 1210 and the second garbage collection 1220 described in FIG. 12A is performed more efficiently than the timing diagram of FIG. 12B.

In more detail, in order to allow the first garbage collection operation 1210 as described in FIG. 12A to be normally performed, an operation 1305 for preparing the first garbage collection is required:

Accordingly, the operation 1305 for preparing the first garbage collection may be performed in a time period starting at a time point T0, which is the first time point, and ending at a time point T1.

In this case, the operation 1305 for preparing the first garbage collection is the same as the operation 1205 for preparing the first garbage collection as described in FIG. 12B. That is, the operation 1305 for preparing the first garbage collection may be performed in a time period starting at time point T0, which is the first time point, and ending at time point T1. In this case, the operation 1305 for preparing the first garbage collection includes the first operation (E1) for confirming whether the first garbage collection may be performed, the second operation (E2) for selecting the victim block VICTIM from the plurality of memory blocks BLK0 to BLK7 included in the memory device 150, the third operation (E3) for calculating the first garbage collection operation time, and the fourth operation (E4) for selecting the target free block FREEB from the plurality of memory blocks BLK0 to BLK7. Accordingly, a detailed description of the first garbage collection preparation operation 1305 will be omitted.

As a result of the first garbage collection preparation operation 1305, among the plurality of memory blocks BLK0 to BLK7, the 0^{th} block BLK0 may be selected as the victim block VICTIM and the first block BLK1 may be selected as the target free block FREEB.

When T1 is reached and the operation 1305 for preparing the first garbage collection is completed, the first garbage collection operation 1310 may be performed.

In more detail, the first garbage collection operation 1310 may be divided into a copying operation (F11) and an erase operation (F21), The copying operation (F11) for respectively copying the data of the 0^{th} page PAGE0 and the fifth page PAGE5, which are the valid pages VALID of the 0^{th} block BLK0, into the 0^{th} page PAGE0 and the first page PAGE1 of the first block BLK1 may be performed in an advanced time period starting at a point of time T1 and ending at a point of time T2. The erase operation (G11) for erasing the 0^{th} block BLK0 may be performed in the subsequent period starting at a point of time T2 and ending at a point of time T3,

The copying operation (F11) is performed between the 0^{th} block BLK0 and the first block BLK1. Accordingly, the second to seventh blocks BLK2 to BLK7 except for the 0^{th} block. BLK0 and the first block BLK1 among the plurality of memory blocks BLK0 to BLK7, may enter a waiting state WAITING (F12) in which no operation is performed.

As described above, the first garbage collection operation 1210 and 1310 performed in the advanced period T1 to T2 is the same in the timing diagram of FIG. 12B and the timing diagram of FIG. 12C. However, it can be understood that the operation (B21) and (G11) for erasing the 0^{th} block BLK0 performed in the subsequent period T2 to T3 is different in the timing diagram of FIG. 12B and the timing diagram of FIG. 12C.

In detail, since the operations (B21) and (G11) for erasing the 0^{th} block BLK0 performed in the subsequent period T2 to T3 should be unconditionally included in and performed with the first garbage collection operation 1210 and 1310, respectively, it is performed in the same manner in FIG. 12B and FIG. 12C.

In the first garbage collection operation 1210 described in FIG. 126, since the operation (B21) for erasing the 0^{th} block BLK0 is performed only in the 0^{th} block. BLK0, the first to seventh blocks BLK1 to to BLK7, except for the 0^{th} block BLK0, may substantially maintain the waiting state WAITING (B22) in which no operation is performed.

However, in the first garbage collection operation 1310 of FIG. 12C, since the operation (G11) for erasing the 0^{th} block BLK0 is performed only in the 0^{th} block BLK0, the first to seventh blocks BLK1 to BLK7, except for the 0^{th} block BLK0, have the waiting state WAITING, but the operation 1315 for preparing the second garbage collection may be allowed to be performed for the first to seventh blocks BLK1 to BLK7, except for the 0^{th} block BLK0. That is, the second garbage collection preparation operation 1315, which is to be performed subsequently to the first garbage collection operation 1310, may be allowed to overlap with the operation of T2 to 13 of the first garbage collection operation 1310. Such overlapping operations may be advantageous.

As a result of the first garbage collection operation 1310, since the 0^{th} block BLK0 is changed to the free block FREEB, it is not subjected to the garbage collection in the second garbage collection operation 1320 which is performed subsequently to the first garbage collection operation 1310. For example, at the time point at which the second garbage collection operation 1320 is performed subsequently to the first garbage collection operation 1310, a result obtained by performing the second garbage collection preparation operation 1305 for all the plurality of memory blocks BLK0 to BLK7 is the same as a result obtained by performing the second garbage collection preparation operation 1315 for the first to seventh blocks BLK1 to BLK7, except for the 0^{th} block BLK0 among the plurality of memory blocks BLK0 to BLK7.

Furthermore, an absolute time of the operation (G11) for erasing the 0^{th} block BLK0 in the first garbage collection operation 1310 may be sufficiently long. That is, the absolute time required for performing the operation (G11) for erasing the 0^{th} block BLK0 may be relatively long due to the characteristics of the nonvolatile memory device. Therefore, it may be possible to sufficiently ensure a time required for performing the second garbage collection preparation operation 1215 including the four operations as described in FIG. 12B.

In this case, the second garbage collection preparation operation 1315 may be the same as the first garbage collection preparation operation 1205 as described in FIG. 12B, except that in the first garbage collection preparation operation 1205, the 0^{th} block BLK0 may be selected as the victim block VICTIM and the first block BLK1 may be selected as the target free block FREEB, whereas in the second garbage collection preparation operation 1315, the fourth block BLK4 selected as the victim block VICTIM and the fifth block BLK5 is selected as the target free block FREEB. Accordingly, a detailed description of the second garbage collection preparation operation 1315 will be omitted.

As described above, as a result obtained by performing the operation (G11) for erasing the 0^{th} block BLK0 in the first garbage collection operation 1310 and the second garbage collection preparation operation 1315 while overlapping each other in a partial operation period, the 0^{th} block BLK0 may be erased and changed as the free block FREEB, the fourth block BLK4 may be selected as the victim block VICTIM of the second garbage collection (G2), and the fifth block BLK5 may be selected as the target free block FREEB of the second garbage collection (G4).

Since the operation (G11) for erasing the 0^{th} block BLK0 in the first garbage collection operation 1310 and the second garbage collection preparation operation 1315 are continuously performed, generally the 0^{th} block BLK0 erased through the first garbage collection operation 1310 and changed as the free block FREEB may be excluded if possible when the target free block FREEB is selected (G4) in the second garbage collection preparation operation 1315. This is because it is possible to ensure the operational stability of a specific block only when an erase operation is performed for the specific block and then a writing operation is not performed for the specific block for a predetermined time due to the characteristics of the nonvolatile memory device.

When T3 is reached and both the first and second garbage collection operations 1310 and 1315 are completed, the second garbage collection operation 1320 may be performed.

In this case, in FIG. 12B, since the second garbage collection preparation operation 1215 has not been completed in T3, the second garbage collection preparation operation 1215 may then be performed. However, in FIG, 12C, since the second garbage collection preparation operation 1315 has already been completed in T3, the second garbage collection operation 1320 may be directly performed.

Accordingly, in FIG. 12B, the second garbage collection operation 1220 may be performed in the time period from T4 to T6, but in FIG. 12C, the second garbage collection operation 1320 may be performed in the time period from T3 to T5. That is as compared with the case in which the second garbage collection operation 1220 is performed in FIG. 12, can be understood that the time point at which the second garbage collection operation 1320 is performed in FIG. 12C may be advanced.

In more detail, the second garbage collection operation 1320 may be divided into a copying operation (H11) and an erase (I11). The copying operation H11 for respectively copying the data of the third page PAGE5 and the fourth page PAGE4, which are the valid pages VALID of the fourth block BLK4, into the 0^{th} page PAGE0 and the first page PAGE1 of the fifth block BLK5 may be performed in the advanced period starting at point of time T3 and ending at point of time T4. The erase operation (I11) for erasing the fourth block BLK4 may be performed in the subsequent period starting at point of time T4 and ending at point of time T5.

The copying operation (H11) for respectively copying the data of the third page PAGES and the fourth page PAGE4, which are the valid pages VALID of the fourth block BLK4, into the 0^{th} page PAGE0 and the first page PAGE1 of the fifth block BLK5 in the advanced period T3 to T4 is performed between the fourth block BLK4 and the fifth block BLK5. Accordingly, the 0^{th} to third blocks BLK0 to BLK3 and the sixth and seventh blocks BLK6 and BLK7, except for the fourth block BLK4 and the fifth block BLK5 among the plurality of memory blocks BLK0 to BLK7, enter a waiting state WAITING (H12) in which no operation is performed.

Furthermore, the operation (I11) for erasing the fourth block BLK4 in the subsequent period T4 to T5 is performed only in the fourth block BLK4. Accordingly, the 0^{th} to third blocks BLK0 to BLK3 and the fifth to seventh blocks BLK5 to BLK7, except for the fourth block BLK4, may enter a waiting state WAITING in which no operation is performed, or may enter a state in which an operation (I12) for preparing third garbage collection is performed when the third garbage collection is performed subsequently to the second garbage collection 1320.

As described above, in the period of erasing the victim block VICTIM completely subjected to an operation for moving internal valid data through the first garbage collection firstly performed among the plurality of memory blocks BLK0 to BLK7 included in the memory device 150, it is possible to prepare the operation of the second garbage collection to be subsequently performed. That is an operation period in which continuous garbage collections overlap each other may be ensured.

Consequently, it is possible to significantly reduce a time required for the continuous garbage collections.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device comprising a plurality of blocks; and
a controller suitable for erasing at least one victim block selected from among the plurality of blocks in a first garbage collection operation, and preparing a second garbage collection operation for one or more other blocks, except for the victim block among the plurality of blocks during a period in which the victim block is erased.

2. The memory system of claim 1, wherein the controller is further suitable for copying valid data of the victim block into a target free block in the first garbage collection operation.

3. The memory system of claim 1, wherein the controller is suitable for preparing the second garbage collection operation for the one or more other blocks by determining whether to perform the second garbage collection operation.

4. The memory system of claim 3 wherein the controller determines whether to perform the second garbage collection operation based on at least one of a host request operation for the memory device, a valid data rate for the one or more other blocks, and a number of free blocks of the plurality of blocks.

5. The memory system of claim 4, wherein the controller determines that the second garbage collection operation is not to be performed when the host request operation for the memory device exists in the period in which the victim block is erased.

6. The memory system of claim 4, wherein the controller determines that the second garbage collection operation is not to be performed when there is no block having a valid data rate lower than a preset rate in the one or more other blocks.

7. The memory system of claim 4, wherein the controller determines that the second garbage collection operation is not to be performed when the number of free blocks of the plurality of blocks is larger than a preset number.

8. The memory system of claim 4, wherein, when it is determined to perform the second garbage collection operation for the one or more other blocks, the controller selects at least one block from among the one or more other blocks, of which the valid data rate is lower than a preset rate, as another victim block to which the second garbage collection operation is applied.

9. The memory system of claim 8, wherein the controller calculates a time required for performing the second garbage collection operation for the another victim block.

10. The memory system of claim 8, wherein the controller selects a target free block among the one or more other blocks for the another victim block based on a number of times of erasing/writing operations.

11. An operation method of a memory system comprising a memory device comprising a plurality of blocks, the operation method comprising:
erasing at least one victim block selected from among the plurality of blocks in a first garbage collection operation; and
preparing a second garbage collection operation for one or more other blocks, except for the victim block among the plurality of blocks, in a period in which the victim block is erased.

12. The operation method of claim 11, wherein further comprising: copying valid data of the victim block into a target free block in the first garbage collection operation.

13. The operation method of claim 11, wherein the preparing of the second garbage collection operation for the one or more other blocks comprises determining whether to perform the second garbage collection operation

14. The operation method of claim 13 wherein the determining of whether to perform the second garbage collection operation comprises:
determining whether to perform the second garbage collection operation based on at least one of a host request operation for the memory device, a valid data rate for the one or more other blocks, and a number of free blocks of the plurality of blocks.

15. The operation method of claim 14, wherein the determining of whether to perform the second garbage collection operation comprises:
when the host request operation for the memory device exists in the period in which the victim block is erased, determining that the second garbage collection is controlled not to be performed.

16. The operation method of claim 14, wherein the determining of whether to perform the second garbage collection operation comprises:
when there is no block having a valid data rate lower than a preset rate in the one or more other blocks, determining that the second garbage collection is controlled not to be performed.

17. The operation method of claim 14, wherein the determining of whether to perform the second garbage collection operation comprises:
when the number of free blocks of the plurality of blocks is larger than a preset number, determining that the second garbage collection is controlled not to be performed,

18. The operation method of claim 14, further comprising:
when it is determined to perform the second garbage collection operation for the one or more other blocks, selecting at least one block to from among the other blocks, of which the valid data rate is lower than a preset rate, as another victim block to which the second garbage collection operation is applied.

19. The operation method of claim 18, wherein the preparing further comprises:
calculating a time required for performing the second garbage collection operation for the another victim block.

20. The operation method of claim 18, wherein the preparing further comprises:
selecting a target free block among the one or more other blocks for the another victim block based on a number of times of erasing/writing.
